(19) United States
(12) Patent Application Publication
(10) Pub. No.: US 2002/0186243 A1
(43) Pub. Date: Dec. 12, 2002

(54) Method and system for providing combined video and physiological data over a communication network for patient monitoring

(76) Inventors: Robert Ellis, Warwick, NY (US); Adrian Parvulescu, Fishs Eddy, NY (US)

Correspondence Address: Larry Liberchuk, Esq., Intellectual Property Department, Sony Electronics Inc., 123 Tice Boulevard - MD T1-1, Woodcliff Lake, NJ, 07677-8402, US

(21) Appl. No.: 09/875,771

(22) Filed: Jun. 6, 2001

(51) Int. Cl. G06F 13/00

(52) U.S. Cl. 345/753

(57) ABSTRACT

A method and system to selectively transmit and receive audio-visual physiological content to and from remote locations using two-way broadband communication technology via an interactive audio-visual appliance having multiple modes of operation. The transmission of audio-visual physiological content may optionally be coupled with the selective transmission and receipt of audio-visual entertainment content information, such as videos, movies, music, etc. between the remote locations, also via the interactive audio-visual appliance. Moreover, the present invention provides videoconferencing capabilities to users between remote locations via the audio-visual appliance.

### FIELD OF THE INVENTION

This invention relates generally to broadband medical applications in general, and more particularly to the bi-directional transmission of combined physiological and other audio-visual content data over a medical communication network.

### BACKGROUND OF THE INVENTION

There exists a variety of diseases and medical conditions that, while not necessarily life-threatening, do require that the medical condition be monitored to ensure that the diagnosis and treatment is successful. Patients having a variety of chronic diseases, such as chronic obstructive pulmonary disease (COPD) or emphysema, diabetes, asthma, congestive heart failure (CHF), for instance, are cared for by monitoring various physiological indicators, such as blood-oxygen saturation levels, blood pressure, blood sugar or glucose levels, EKG, etc.

Monitoring certain medical conditions currently requires that the patient be physically available to health care professionals in a health care setting, such as at a hospital or clinic. Patients are often kept in the health care environment, at considerable expense, so that their condition can be monitored, even when the condition is not life-threatening. The need to monitor the condition of the patient “on-site” therefore represents an inefficient use of resources in the medical community and can adversely impact the quality of life of the patient. Work and family life is disrupted, for potentially long periods of time, while the patient's physiological indicators are measured and analyzed. This is especially true of chronic medical conditions.

Given this reality, there is a recognized need in the art to be able to, whenever possible, monitor the health of a patient outside the traditional health care environment. There exist certain low-end, low-bandwidth video monitoring devices, capable of measuring certain physiological conditions, such as blood pressure and glucose levels for diabetes, and transmitting this information as data over standard telephone lines where it can be received and analyzed by a qualified health care professional. While this represents an improvement in the art insofar as it allows certain limited, non-interactive communication of physiological data between patient and health-care professional, it is hardly a satisfactory solution for many diseases and medical conditions and does not enhance the quality of the doctor-patient relationship. It is a unilateral, non-interactive communication that provides only limited data and does not allow for the kind of dialog in real-time that is so often necessary to diagnose and treat chronic medical conditions and illnesses. For instance, since only physiological data is transmitted, no audio-visual information can be exchanged between the patient and the doctor/hospital. A doctor would thus not be able to ask a question of the patient or provide constructive advice to the patient, in response to receiving the patient's physiological data. Moreover, there are certain physiological indicators, such as the pallor of a patient's skin and labored breathing, which cannot be perceived via transmission using such monitoring devices.

### SUMMARY OF THE INVENTION

According to the present invention, physiological content is transmitted between remote locations. Physiological data is collected and provided to a first interactive audio-visual appliance at a first location during a remote communication mode of the first interactive audio-visual appliance. The physiological data is transmitted from the first interactive audio-visual appliance to a second interactive audio-visual appliance at a second location during the remote communication mode of the first interactive audio-visual appliance via a bi-directional broadband transmission medium.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1A illustrates an interactive audio-visual appliance, according to the present invention.

FIG. 1B illustrates an interactive audio-visual appliance separate from and in communication with a display element, according to an aspect of the present invention.

FIG. 2 illustrates a system block diagram of an interactive audio-visual appliance, in accordance with the present invention.

FIG. 3 illustrates an audio-visual communication system that uses the Internet as a communications link, according to an aspect of the present invention.

FIG. 4 illustrates a system in which a patient at a remote location is able to exchange physiological information and audio-visual information with a central location, according to the present invention.

FIG. 5 illustrates a block diagram for the exemplary interactive broadband communication system, according to the present invention.

FIG. 6 illustrates an exemplary system configuration for a digital set-top box, in accordance with the present invention.

### DESCRIPTION OF THE INVENTION

The present invention provides the ability to selectively transmit and receive audio-visual physiological content to and from remote locations using two-way broadband communication technology via an interactive audio-visual appliance. Upon receipt, the audio-visual physiological content may be merged with a patient's electronic medical record (EMR) and stored at an off-site storage location, in conformance with the DICOM (Digital Imaging and Communications in Medicine) standard, from which the physiological content can be retrieved as needed. The transmission of audio-visual physiological content may optionally be coupled with the selective transmission and receipt of audio-visual entertainment content information, such as videos, movies, music, etc. between the remote locations, also via the interactive audio-visual appliance. Moreover, the present invention provides videoconferencing capabilities to users between remote locations via the audiovisual appliance if desired.

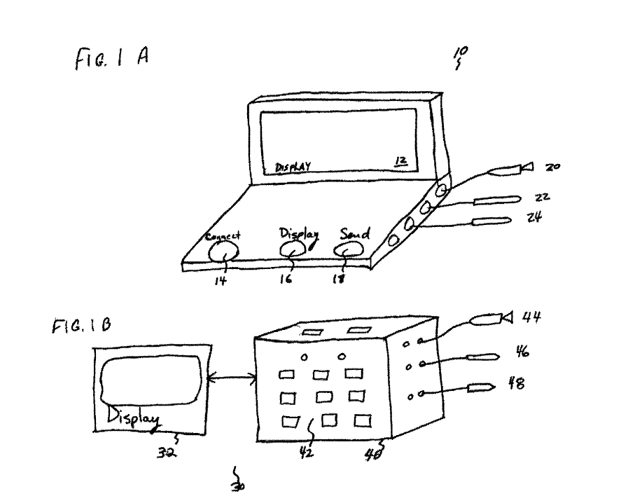

The method and system of the present invention, in providing for the transmission and receipt of physiological content data between a patient and his or her healthcare provider, relies upon one or more interactive audio-visual (AV) appliances having other functionality that is unrelated to the transmission of physiological data. In FIGS. 1A and 1B, two types of interactive audio-visual appliances suitable for use with the present invention are shown. Both types of appliances provide for the selective transmission and receipt of monitored physiological content collected using one or more probes. In the preferred embodiment of the invention, the interactive AV appliance is a suitably augmented set-top box suitable for delivering entertainment content to subscribers. The operation of these multiple mode appliances will be described in more detail below.

Referring now to FIG. 1A, interactive AV appliance 10 is illustrated as a set-top box featuring an integrated display 12. During a first, normal operating mode, the user of appliance 10 can selectively receive entertainment content, such as movies, videos, music, etc. Appliance 10 has a control panel having additional interface mechanisms that allow a user to access additional functionality of the present invention during other modes of operation. During a second mode of operation, called a remote communication mode of operation, the user can send physiological content, collected at probes 20-24, to a remote location and can additionally communicate, via videoconferencing with person or persons at the remote location. The probes 20-24 are used to collect various types of physiological data from a patient, such as blood pressure, blood sugar, etc.

Entry into the second, remote communication mode of appliance 10 may be prompted by the user pressing the connect button 14, manifesting the desire of the user to connect to his health care provider to transmit physiological data or to otherwise communicate with a person at a remote location. Entry into this secondary mode may alternately be accomplished by the user commencing the collection of physiological data via one or more probes 20-24 coupled to corresponding ports of appliance 10, thereby manifesting the intent to transmit physiological content to a remote location. Manipulation of the send button 18 allows the appliance user to decide when to send the physiological data to his health care provider. The display button 16 allows the user to control the display of appliance 10. This is useful, for instance, when the user wishes to teleconference with a person or persons at the remote location and thus needs to be able to see them remotely. Operation of the interface of appliance 10 may alternately be accomplished using a remote control device to manipulate appliance 10 and thus accomplish entry into the various modes of operation of appliance 10.

In addition to the display being integrated into the interactive AV appliance, the appliance 40 may be separate from and in communication with a display element 32, as shown in block diagram 30 of FIG. 1B. Display element 32 is commonly a television, such as a digital television, that displays programming, web pages, etc. available for viewing by the set-top box user. Appliance 40, similar to set-top boxes in the art but incorporating additional circuitry to enable the multiple modes of operation of the present invention, has a control panel 42 having buttons that allow the user to manipulate operation of the appliance. One or more probes 44-48, suitable for collecting physiological data from a patient, plug into corresponding ports of appliance 40.

The interactive audio-visual appliance described above facilitates the communication of physiological and other data between a patient and person or persons at a location remote from the patient. It is envisioned that the system utilizes an interactive audiovisual appliance at the patient location, referred to as location1, as well as at the location remote from the patient, referred to as location 2. Communication between these locations is facilitated by communication between these interactive audio-visual appliances. It is not, however, a requirement of the present invention, that the device at the non-patient location2 also be an interactive audio-visual appliance; any communication device suitable for receiving the patient's physiological data and communicating with the patient at location1 is envisioned within the system of the present invention.

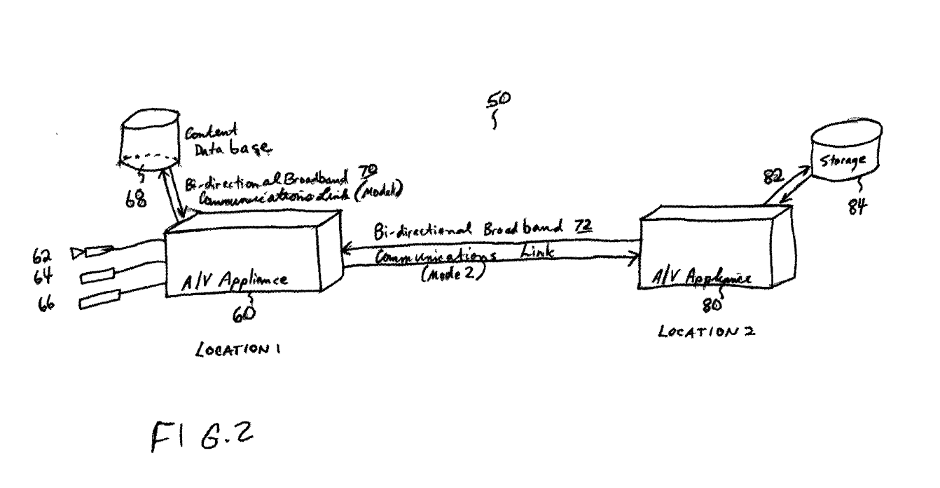

Referring now to FIG. 2, a system block diagram 50 in accordance with the present invention is shown. Interactive audio-visual appliance 60 resides at location1 while interactive audio-visual appliance 80 resides at remote location2. During the first, normal mode of operation of appliance 60, a user of appliance 60 is able to receive entertainment content, such as movies, video, music, trailers, interviews, etc., from content database 68 via bi-directional broadband transmission medium 70. Communication of physiological data, which may include image data, to interactive appliance 80 at the remote location 2 during the second mode of operation of interactive appliance 60 is accomplished via bi-directional broadband transmission medium 72. As previously mentioned, entry into the second mode of operation of appliance 60 may be accomplished a number of ways, including activation of a connect mechanism or other mode two entry mechanism by the user, or by commencing the collection of physiological data from the patient via probes 62-64. Upon receipt of physiological content from appliance 60, the health care provider can analyze the physiological data to monitor the patient's health and make necessary diagnostic and treatment adjustments as needed. The bi-directional broadband transmission medium 72 allows the health care provider to communicate, in real time and via videoconferencing if so desired, with the patient at location1. The physiological content received at interactive appliance 80 may at some point be merged with the patient's EMR and downloaded for long-term storage to storage element 84 via communication link 82. The operation of the first and second modes of operation internal to appliance 60 will be discussed in more detail below.

It is envisioned that the exchange of physiological content data between the patient and health-care professionals at remote locations during the second mode of operation occurs via a bi-directional broadband communications link or transmission medium, shown as communications link 72. Transmission medium 72 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known transmission media. In the case of a cable television network, transmission medium 20 is commonly realized at the subscriber's premises as a coaxial cable that is connected to a suitable cable connector at the rear panel of the set-top box appliance 60. In the case of a Direct Satellite System (DSS), the appliance 60 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the appliance 60. In other embodiments, bi-directional communication can be effected using asymmetrical communication techniques possibly using dual communication media—one for the uplink and one for the downlink. In any event, the interactive audio-visual appliance can have its own Universal Resource Locator (URL), IP address or other unique identifier assigned thereto to provide for addressability by the head end and users of the Internet.

In addition to being able to transmit physiological data between a patient at location1 and the patient's health care provider at location2, the patient is additionally able to send and receive video mail or conduct video conferencing with a person at remote location2 during the second mode of operation of the interactive appliance. Such video mail or conferencing may or may not additionally include the physiological data discussed above. It is thus possible that a person at location2 who is a family member, friend, or work of the patient who can keep in regular communication with the patient via the use of interactive audio-visual appliance 80 in the second mode at their remote location. This is an especially valuable arrangement in those situations in which the patient may remain in the hospital at location1 for an extended period of time but his family must return to work.

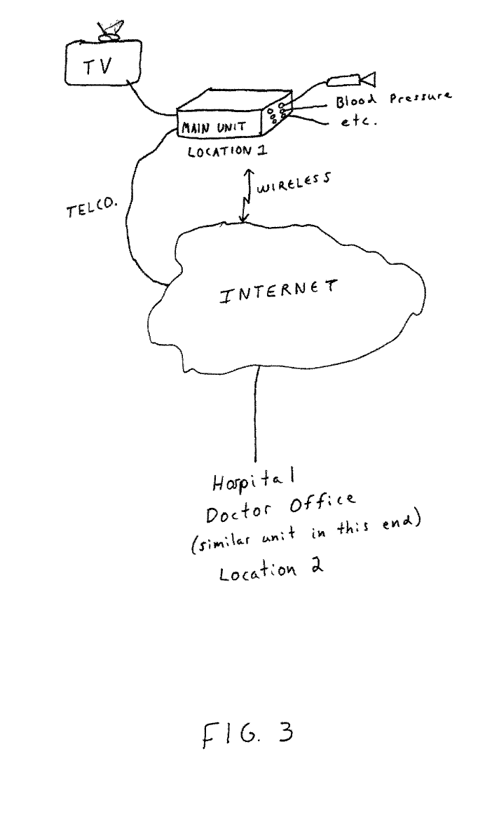

Communication of physiological content data and other information between a patient at location1 and others at location2 occurs via the Internet in accordance with an embodiment of the present invention. The Internet is a ready-made, highly flexible broadband transmission medium especially well-suited to the transmission and reception of audio-visual data between potentially changing locations. Referring now to FIG. 3, a system that uses the Internet as communications link 72 is shown. In this exemplary system, physiological data can be sent from location1 to the Internet via wireless technology or a traditional telephone line communication medium. The Internet service provider as will be explained in more detail delivers the physiological data to the recipient identified in the Internet address entered by a user at location1. In this exemplary figure, the intended recipient may be a doctor or nurse at a hospital, doctor's office, extended care or assisted living facility, or nursing home at location2.

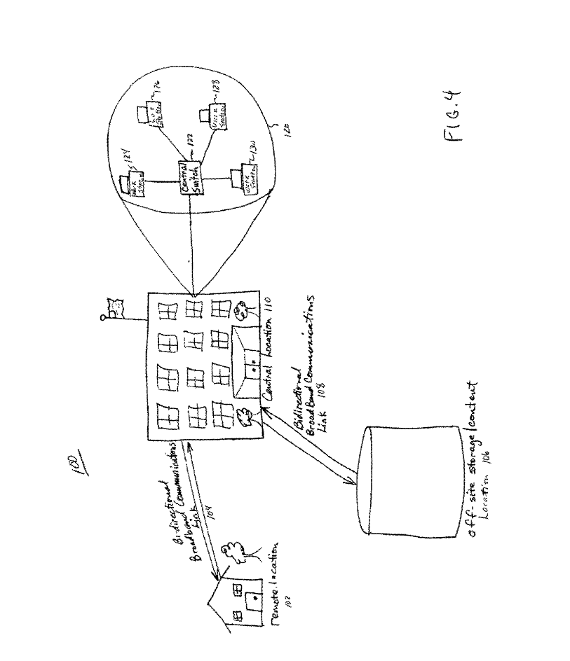

Another exemplary embodiment of the present invention is illustrated in the system block diagram 100 of FIG. 4. In this figure, a patient at home at remote location 102, remote with respect to the hospital at central location 110, has been discharged from the hospital by his doctor and given a prescription for an interactive audio-visual appliance and suitable probes with which to measure certain necessary physiological conditions of the patient and which may be rented by the patient as long as needed; alternately, the patient may already have possession of the interactive appliance, such as a set-top box, at his home and would only require the probes necessary to take the physiological measurements. In accordance with his doctor's instructions, the patient uses the probes to periodically measure the needed physiological indicators and transmit those to the doctor at the hospital, doctor's office, or other central location 110 via bi-directional broadband transmission medium 104 (such as via the Internet). Additionally, it is anticipated that the medical information sent from the patient to his health care provider can be accessed by additional persons who might assist in the diagnosis and treatment of the patient's condition. These persons may themselves be at yet another location, remote from the hospital, but can still access the information in the patient's EMR if they have the necessary access privileges. Moreover, these people may need to also interact directly with the patient. For instance, there may be several consulting doctors, at different hospitals, that are working together to chart the patient's progress and plot treatment strategy. The Internet provides an excellent bi-directional broadband transmission medium particularly conducive to supporting this goal.

The doctor or other health-care professional receives the physiological measurements from the patient and uses them to monitor the patient's progress and make any necessary changes to the patient's treatment plan. Feedback or instructions to the patient may be sent back to the patient at remote location 102 also via bi-directional broadband transmission medium 104, in real-time if desired. Or, if communication from the doctor back to the patient will not occur until a later time, the interactive audio-visual appliance or perhaps television at the patient's remote location will notify the patient when information from the health-care provider is received. For instance, a red light might flash on the television to notify the patient that a video conference is being initiated or that videomail is waiting. This information may come in the form of e-mail transmitted via the Internet, for instance.

In a preferred embodiment of the present invention, audio-visual information received at central location 110 from the patient at remote location 102 is processed by central switch 122, such as by a server station inside the hospital or doctor's office. The health-care provider, if he has the necessary access privilege, can then access the patient's information at any workstation 124-130 within central location 110. This provides the health-care provider with a degree of flexibility as well, by not requiring that the patient information only be required at one physical location, such as a certain computer terminal, within central location 110. The health-care provider can access not only the recently received transmission from the patient but the patient's entire electronic medical record (EMR) at any workstation if he has the appropriate permission. The EMR may be stored at an off-site storage/content database 106 and can be retrieved as needed via bi-directional broadband communications link 108, which may also be via the Internet if desired. The physiological content information and other communications from the patient may be merged with the patient's EMR at some future time and stored in the off-site storage location, available for future retrieval, when no longer needed. Appropriate security, such as encryption, digital certificates or biometric verification (fingerprint and infrared (IR) scanning), may be utilized to protect the privacy of the patient's medical information. It is further envisioned that the off-site storage database 106 may additionally be a content database containing entertainment content, such as movies, videos, music, interviews, games, etc., to be accessed by patients, perhaps inside the hospital in hospital beds, having access to the interactive audio-visual appliances of the invention during the normal mode of operation of such appliances. The patient uses the same interactive appliance to access content, such as music, movies, and video games, as well as to send medical data, including video and audio, back and forth to the health-care providers within the hospital. In this instance, the content provided from off-site storage/content database 106 represents a revenue stream for both the hospital and the content provider.

The use of an off-site storage database 106 capable of being accessed as needed represents an improvement in back-end medical storage and retrieval (archival) systems capable of storing medical images and other information conforming to the DICOM standard, an interface specification that describes how digital image management devices can communicate. The cost of such archiving of medical records on-site at the individual hospital or health-care facility is prohibitive, representing a huge capital investment by the hospital. The necessary picture archive and communication system (PACS) equipment is expensive and must be configured and maintained by highly skilled information technologists. Moreover, the storage capabilities of these systems improves significantly every three to five years, necessitating the need to invest in new equipment. This capital outlay is often replicated by each hospital with little sharing of equipment costs and maintenance occurring between multiple hospitals. The off-site storage database 106 of FIG. 4 can easily be used by multiple hospitals or health-care facilities if the necessary privacy structures are put into place, thereby spreading the cost of archival and retrieval across multiple users.

In an exemplary embodiment of the invention, the interactive appliance is a set-top box within the two-way broadband communication system. As will be described, it is also envisioned that the functionality of the interactive appliance may be satisfied by placing the set-top box functionality within the television to which the set-top box is coupled or as part of a computer having a tuner device and modem that encompasses the functionality of the television and set-top box. The set-top box of the present invention has multiple functionality represented by a normal operating mode and a remote communication mode.

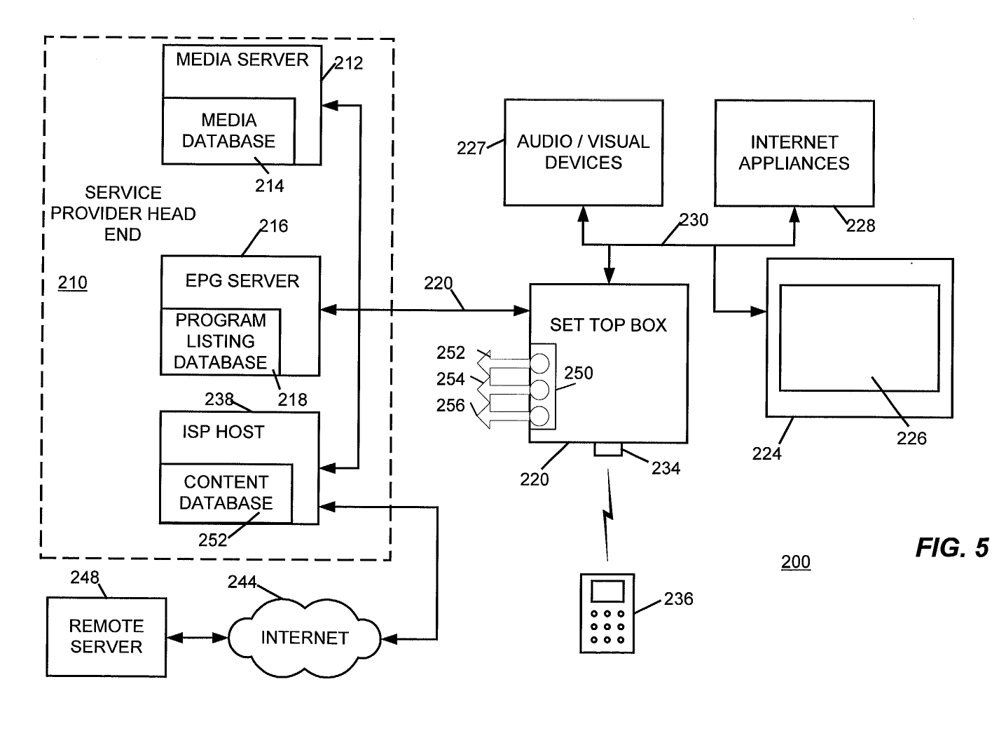

Referring now to FIG. 5, a block diagram for the exemplary interactive broadband communication system 200 of the present invention is shown. The system 200 includes, at a head end of the service provider 210, a media server 212 for providing, on demand, movies and other programming obtained from a media database 214. Service provider 210 may be thought of as a content provider insofar as it delivers such entertainment content to the set-top box 222 during the normal operating mode of set-top box 222. The media server 212 might also provide additional content such as interviews with the actors, games, advertisements, available merchandise, associated Web pages, interactive games and other related content. The system 200 also includes an information server 216 and a program listing database 218.

The program listing database 218 may contain a list of scheduled broadcast programs and programs available on-demand to a user of the system during the normal operating mode of set-top box 222. The program listing database 218 of information server 216 of service provider 210 conveys a number of information attributes about available audio or audio/visual objects to the set-top box 222. These audio/visual information attributes may include, by way of example and not limitation, one or more of the following: an identifier of the object such as the name of the object, the name of author of the selection such as the artist of a song or album, a schedule attribute including the precise start time and duration of the object (contained within the schedule information provided by program listing database 218), the location of the selected audio/visual object, and copy and access control information. Selection information, such as timing information about the start and end points of an audio/visual object, can be included in the transport stream (TS) received by the set-top box from the service provider head end 210. For instance, attribute information needed to select the object can be included in a MPEG-2 Transport Stream in the form of MPEG-2 table sections; the reader is referred to, for example, the EIA/CEA-775.2 Service selection information for digital storage media interoperability standard. The timing information contained in the TS from the service provider 210 may be used to mark the boundary points, such as the file start and end points, of the audio/visual object.

While the arrangement illustrated in FIG. 5 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 5 may actually reside in other locations, but from the perspective of the user of STB 222, the service provider 210 serves as a portal to the services shown. Those skilled in the art will appreciate that the illustration of FIG. 5 represents a simplified depiction of a cable system configuration shown simply as service provider 10. The simplified illustration shown is intended to simplify the discussion of the service provider 210's operation without unnecessarily burdening the discussion with architectural details that will be evident to those skilled in the art.

The media server 212 and information server 216 are operatively coupled by transmission medium 220 to a set-top box (STB) 222. The transmission medium 220 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission media. In the case of a cable television network, transmission medium 220 is commonly realized at the subscriber's premises as a coaxial cable that is connected to a suitable cable connector at the rear panel of the STB 222. In the case of a Direct Satellite System (DSS), the STB 222 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 222.

The exemplary system 200 further includes a TV 224, such as a digital television, having a display 226 for displaying programming, web pages, etc. The STB 222 may be coupled to the TV 24 and various other audio/visual devices 227 (such as another interactive audio-visual device functionally equivalent to STB 222, audio systems, Personal Video Recorders (PVRs), Video Tape Recorders (VTRs), Video Cassette Recorders (VCRs) and the like), storage devices (e.g., hard disc drives) and Internet Appliances 228 (such as email devices, home appliances, storage devices, network devices, and other Internet Enabled Appliances) by an appropriate interface 230, which can be any suitable analog or digital interface. In one embodiment, interface 230 conforms to an interface standard such as the Institute of Electrical and Electronics Engineers (IEEE) 1394 standard, but could also be wholly or partially supported by a DVI interface (Digital Visual Interface-Digital Display Working Group, www.ddwg.org) or other suitable interface.

As previously discussed STB 222 has a second, remote communication mode during which physiological content data of the patient obtained from medical probes 252-256 and presented to probe interface 250 of STB 222. This physiological data, which may include images as well as other data, is communicated via bi-directional transmission medium 230 to a person at a remote location, represented by A/V devices 227. As discussed, this information may be received by another STB functionally similar to STB 222. Other types of A/V devices 227 may include such devices as a personal computer, video cassette recorder, camcorder, digital camera, personal digital assistant and other audio/visual or Internet related devices. In addition, a data transport architecture may be utilized to enable interoperability among devices on a network regardless of the manufacturer of the device if the manufacturers agree to adhere to an industry standard. The STB 222 normally runs an operating system suitable for a home network system.

The STB 222 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 220. STB 222 may include circuitry suitable for audio decoding and processing, the decoding of video data compressed in accordance with a compression standard such as the Motion Pictures Experts Group (MPEG) standard and other processing to form a controller or central hub. Alternatively, components of the STB 222 may be incorporated into the TV 224 itself, thus eliminating the STB 222. Further, a computer having a tuner device and modem may be equivalently substituted for the TV 224 and STB 222.

The STB 222 includes an infrared (IR) receiver 234 for receiving IR signals from an input device such as remote control 236. Alternatively, it is noted that many other control communication methods may be utilized besides IR, such as wired or wireless radio frequency, etc. In addition, it can be readily appreciated that the input device 236 may be any device suitable for controlling the STB 222 such as a remote control, personal digital assistant, laptop computer, keyboard or computer mouse. In addition, an input device in the form of a control panel located on the TV 224 or the STB 222 can be provided.

The STB 222 may also be coupled to an independent service provider (ISP) host 238 by a suitable connection including dial-up connections, DSL (Digital Subscriber Line) or the same transmission medium 220 described above (e.g., using a cable modem) to, thus, provide access to services and content from the ISP and the Internet. The ISP host 238 provides various content to the user that is obtained from a content database 252. STB 222 may also be used as an Internet access device to obtain information and content from remote servers such as remote server 248 via the Internet 244 using host 238 operating as an Internet portal, for example. In certain satellite STB environments, the data can be downloaded at very high speed from a satellite link, with asymmetrical upload speed from the set-top box provided via a dial-up or DSL connection.

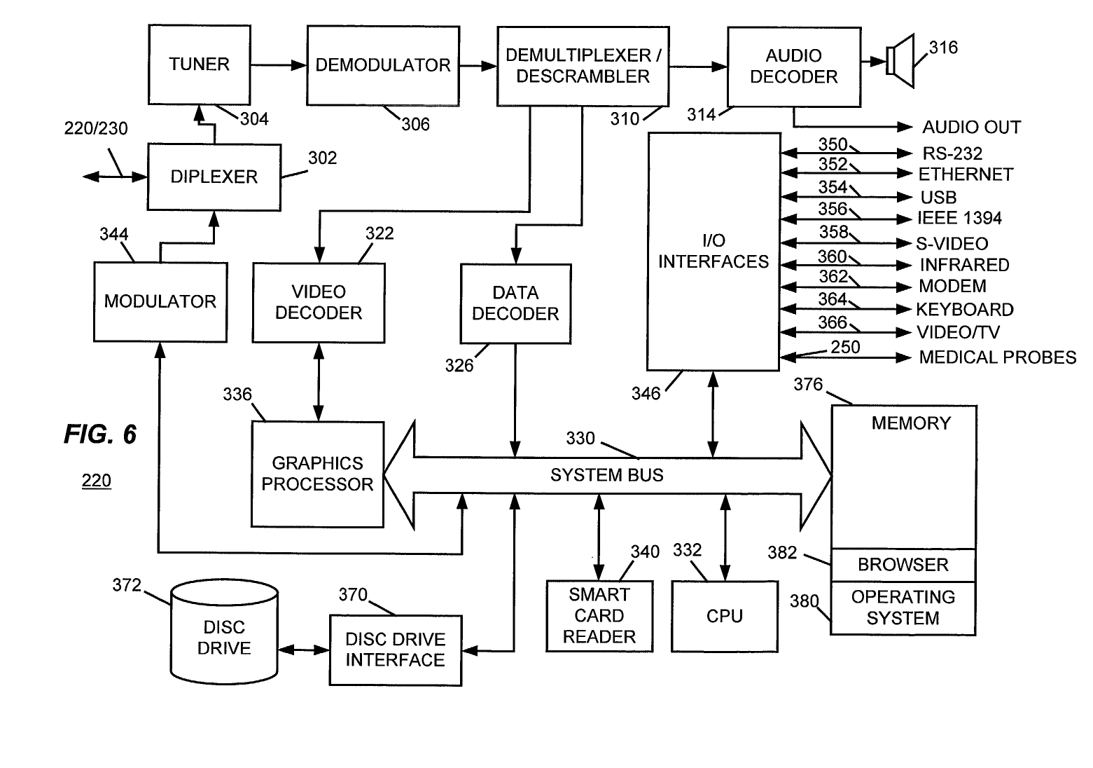

As previously mentioned, the interactive audio-visual appliance 222 in an exemplary embodiment of the present invention is a set-top box within the interactive cable or satellite television (TV) system just described in FIG. 1. Referring now to FIG. 6, a system configuration for such a digital set-top box 222 is illustrated. The STB 222 has been augmented to included medical probe I/O interface 250, representative of medical content collected from a patient via medical probes 252-256 that can be transmitted to a remote location during a second, remote communication mode of the STB 222. It is anticipated that the interactive audio-visual appliance will interface to a PC but is capable of functioning as a stand-alone video communication device. Functionality of the appliance may be limited to real-time video-conferencing, and storing and forwarding video mail.

In this exemplary set-top box, the transmission media 220 and 230, such as a coaxial cable or wireless, is coupled by a suitable interface through a diplexer 302 to a tuner 304. Tuner 304 may, for example, include a broadcast in-band tuner for receiving content, an out-of-band (OOB) tuner for receiving data transmissions. A return path through diplexer 302 provides an OOB return path for outbound data (destined for example for the head end). A separate tuner (not shown) may be provided to receive conventional RF broadcast television channels. Modulated information formatted, for example, as MPEG-2 information is then demodulated at a demodulator 306. The demodulated information at the output of demodulator 306 is provided to a demultiplexer and descrambler circuit 310 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 310 also descrambles scrambled information in accordance with a decryption algorithm to prevent unauthorized access to programming content, for example.

Audio packets from the demultiplexer 310 (those identified with an audio PID) are decrypted and forwarded to an audio decoder 314 where they may be converted to analog audio to drive a speaker system (e.g., stereo or home theater multiple channel audio systems) or other audio system 316 (e.g., stereo or home theater multiple channel amplifier and speaker systems) or may simply provide decoded audio out at 318. Video packets from the demultiplexer 310 (those identified with a video PID) are decrypted and forwarded to a video decoder 322. In a similar manner, data packets from the demultiplexer 310 (those identified with a data PID) are decrypted and forwarded to a data decoder 326.

Decoded data packets from data decoder 326 are sent to the set-top box's computer system via the system bus 330. A central processing unit (CPU) 332 can thus access the decoded data from data decoder 326 via the system bus 330. Video data decoded by video decoder 322 is passed to a graphics processor 136, which is a computer optimized to processes graphics information rapidly. Graphics processor 336 is particularly useful in processing graphics intensive data associated with Internet browsing, gaming and multimedia applications. It should be noted, however, that the function of graphics processor 336 may be unnecessary in some set-top box designs having lower capabilities, and the function of the graphics processor 336 may be handled by the CPU 332 in some applications where the decoded video is passed directly from the demultiplexer 310 to a video encoder. Graphics processor 336 is also coupled to the system bus 330 and operates under the control of CPU 332.

Many set-top boxes such as STB 222 may incorporate a smart card reader 340 for communicating with a so called “smart card,” often serving as a Conditional Access Module (CAM). The CAM typically includes a central processor unit (CPU) of its own along with associated RAM and ROM memory. Smart card reader 340 is used to couple the system bus of STB 222 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

TB 222 can operate in a bi-directional communication mode so that data and other information can be transmitted not only from the system's head end to the end user, or from a service provider to the end user of the STB 222, but also, from the end user upstream using an out-of-band channel. In one embodiment, such data passes through the system bus 330 to a modulator 344 through the diplexer 302 and out through the transmission medium 220/230. This capability is used to provide a mechanism for the STB 222 and/or its user to send information to the head end (e.g., service requests or changes, registration information, etc.) as well as to provide fast outbound communication with the Internet or other services provided at the head end to the end user.

Set-top box 222 may include any of a plurality of I/O (Input/Output) interfaces represented by I/O interfaces 346 that permit interconnection of I/O devices to the set-top box 222. In the present invention, for instance, physiological data collected from a patient via probes 252-256 is presented to STB 222 via interface 250. By way of example, and not limitation, a serial RS-232 port 350 can be provided to enable interconnection to any suitable serial device supported by the STB 222's internal software. Similarly, communication with appropriately compatible devices can be provided via an Ethernet port 352, a USB (Universal Serial Bus) port 354, an IEEE 1394 (so-called firewire™ or i-LINK™) or IEEE 1394 port 356, S-video port 358 or infrared port 360. Such interfaces can be utilized to interconnect the STB 222 with any of a variety of accessory devices such as storage devices, audio/visual devices 227, gaming devices (not shown), Internet Appliances 228, etc.

I/O interfaces 346 can include a modem (be it dial-up, cable, DSL or other technology modem) having a modem port 362 to facilitate high speed or alternative access to the Internet or other data communication functions. In one preferred embodiment, modem port 362 is that of a DOCSIS (Data Over Cable System Interface Specification) cable modem to facilitate high speed network access over a cable system, and port 362 is appropriately coupled to the transmission medium 220/230. Thus, the STB 222 can carry out bi-directional communication via the DOCSIS cable modem with the STB 222 being identified by a unique IP address. The DOCSIS specification is publicly available. Of course, it is envisioned that the modem can be part of the set-top box.

A PS/2 or other keyboard/mouse/joystick interface such as 364 can be provided to permit ease of data entry to the STB 222. Such inputs provide the user with the ability to easily enter data and/or navigate using pointing devices. Pointing devices such as a mouse or joystick may be used in gaming applications.

Of course, STB 222 also may incorporate basic video outputs 366 that can be used for direct connection to a television set such as 224 instead of (or in addition to) an IEEE 1394 connection such as that illustrated as 356. In one embodiment, Video output 366 can provide composite video formatted as NTSC (National Television System Committee) video.

The infrared port 360 can be embodied as an infrared receiver 234 as illustrated in FIG. 5, to receive commands from an infrared remote control 236, infrared keyboard or other infrared control device. Although not explicitly shown, front panel controls may be used in some embodiments to directly control the operation of the STB 222 through a front panel control interface as one of interfaces 346. Selected interfaces such as those described above and others can be provided in STB 222 in various combinations as required or desired.

STB 222 will more commonly, as time goes on, include a disc drive interface 370 and disc drive mass storage 372 for user storage of content and data as well as providing storage of programs operating on CPU 332. STB 222 may also include floppy disc drives, CD ROM drives, CD R/W drives, DVD drives, etc. CPU 332, in order to operate as a computer, is coupled through the system bus 330 (or through a multiple bus architecture) to memory 376. Memory 376 may include a combination any suitable memory technology including Random Access Memory (RAM), Read Only Memory (ROM), Flash memory, Electrically Erasable Programmable Read Only Memory (EEPROM), etc.

While the above exemplary system including STB 222 is illustrative of the basic components of a digital set-top box suitable for use with the present invention, the architecture shown should not be considered limiting since many variations of the hardware configuration are possible without departing from the present invention.

In general, during operation of the STB 222, an appropriate operating system 380 is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 222 usually operates using browser software 382 in active memory or may permanently reside in ROM, EEPROM or Flash memory, for example. The browser software 382 typically operates as the mechanism for viewing not only web pages on the Internet, but also serves as the mechanism for viewing an Electronic Program Guide (EPG) formatted as an HTML document.

The transmission and receipt of physiological data between a patient and medical provider, such as a doctor, nurse, clinic, hospital, extended care facility, assisted living facility, or nursing home, allows the health of the patient at a location remote from the health-care professional to be monitored and diagnosis and treatment to take place, all without requiring the patient to leave the remote location. Patients having a variety of diseases, such as chronic obtrusive pulmonary disease (COPD) or emphysema, diabetes, asthma, congestive heart failure, for instance, can be cared for by monitoring various physiological indicators, such as blood-oxygen saturation levels, blood pressure, blood sugar or glucose levels, EKG, audio, and video image, that are transmitted as physiological content data via a two-way broad-band communications link, such as the Internet, from the patient to the heath care provider at a location that is remote from the patient. Instructions, advice, encouragement, and data may subsequently be forthcoming from the health care provider to the patient at the remote location. The ability to monitor the physiological health indicators of a patient at a remote location, such as the patient's home or place of business, results in substantial cost savings. It is no longer necessary for a patient having a non-life threatening, chronic condition to remain in a health care setting just to have certain physiological indicators monitored. Moreover, the interactive exchange of physiological data between patient and the health care provider at a remote location improves the quality of care that is delivered to the patient.

The present invention also provides the benefit of allowing the patient and family to resume normal activities to the largest extent possible. In addition to the patient taking an interactive appliance home from the hospital, for instance, family members or work partners of the patient can additionally use the appliance, perhaps through a lease program, to permit them to stay in contact with the patient even when at remote locations through direct, real-time videoconferencing or voice mail. The invention is also ideal for hospital admissions of more than one day; family/friends can stay in contact with hospitalized patient during the entire hospital stay. It is specially beneficial for the families of hospitalized children, such as the parents of prematurely born infants who typically have hospital stays in excess of 10 days; the relatives and family friends of a newborn infant who could use the invention to make direct contact and offer congratulations; post-operative patients would be aided in the recovery process by tele-visits from family members; and families with aging parents in nursing homes or extended care facilities would be able to visit and communicate more frequently.

While the invention has been particularly shown and described with reference to a preferred embodiment, it will be understood by those skilled in the art that various changes in form and detail may be made therein without departing from the spirit and scope of the invention.

What is claimed is:

1. A bi-directional broadband communication system suitable for exchanging audiovisual content information between remote locations, comprising:
a first interactive audio-visual appliance at a first location;
one or more collection elements operably coupled to the first interactive audio-visual appliance and suitable for collecting one or more physiological data; and
a second interactive audio-visual appliance at a second location;
wherein during a remote communication mode of operation of the first interactive audio-visual appliance a user can select to transmit via a bi-directional broadband transmission media to the second interactive audio-visual appliance the one or more physiological data collected by the one or more collection elements.

2. The system of claim 1, wherein the first interactive audio-visual appliance is a set-top box.

3. The system of claim 1, wherein the bi-directional transmission media coupling the first and second interactive audio-visual appliances comprises the Internet.

4. The system of claim 1, wherein in response to receiving the one or more physiological data transmitted by the first interactive audio-visual appliance during the second mode of operation, a second user of the second interactive audio-visual appliance can select to transmit audio-visual information to the first interactive audio-visual appliance via the bi-directional transmission media.

5. The system of claim 1, wherein the remote communication mode of operation is entered in response to the user of the first interactive audio-visual appliance selectively activating a mode selection element of the first interactive audio-visual appliance.

6. The system of claim 1, wherein said system further comprises:
one or more databases, coupled to the second interactive audio-visual appliance, to which the one or more physiological data transmitted to the second interactive is stored.

7. The system of claim 1, wherein the one or more physiological data is merged with an electronic medical record in the one or more databases.

8. A bi-directional broadband communication system suitable for exchanging audiovisual content information between remote locations, comprising:
a first interactive audio-visual appliance at a first location having a first mode of operation, a second mode of operation, and a mode selection element for allowing a user of the interactive audio-visual appliance to selectively enter the first and second modes of operation;
one or more collection elements operably coupled to the first interactive audio-visual appliance and suitable for collecting one or more physiological data;
a content server coupled to the interactive audio-visual appliance and having access to a content database; and
a second interactive audio-visual appliance at a second location;
wherein during the first mode of operation a user of the interactive audio-visual appliance can receive audio-visual content information selected by the user and received from the content database of the content server;
wherein during the second mode of operation the user of the interactive audio-visual appliance can select to transmit via a bi-directional broadband transmission media to the second interactive audio-visual appliance the one or more physiological data collected by the one or more collection elements.

9. The system of claim 8, wherein the first interactive audio-visual appliance is a set-top box.

10. The system of claim 8, wherein the bi-directional transmission media coupling the first and second interactive audio-visual appliances comprises the Internet.

11. The system of claim 8, wherein in response to receiving the one or more physiological data transmitted by the first interactive audio-visual appliance during the second mode of operation, a second user of the second interactive audio-visual appliance can select to transmit audio-visual information to the first interactive audio-visual appliance via the bi-directional transmission media.

12. The system of claim 8, wherein said system further comprises:
one or more databases, coupled to the second interactive audio-visual appliance, to which the one or more physiological data transmitted to the second interactive is stored.

13. The system of claim 12, wherein the one or more physiological data is merged with an electronic medical record in the one or more databases.

14. An interactive audio-visual appliance, comprising:
a control element;
an interface element controlled by the control element by which a user of the interactive audio-visual appliance selectively controls operation of the interactive audiovisual appliance during a first mode of operation and a second mode of operation of the interactive audio-visual appliance;
a mode selection element controlled by the control element for allowing a user of the interactive audio-visual appliance to selectively enter the first and second modes of operation;
a plurality of ports controlled by the control element and suitable for accepting one or more physiological data collected by a plurality of corresponding probes coupled to the plurality of ports;
wherein during the second mode of operation the user of the interactive audio-visual appliance can select to transmit via a bi-directional broadband transmission media to a second interactive audio-visual appliance the one or more physiological data presented to the plurality of ports;

15. The appliance of claim 14, wherein the interface element is a control panel operable to receive selection inputs to the interactive audio-visual appliance.

16. The appliance of claim 14, wherein the interactive audio-visual appliance is a set-top box.

17. The appliance of claim 14, wherein the bi-directional broadband transmission media comprises the Internet.

18. The appliance of claim 14, wherein during the first mode of operation the user of the interactive audio-visual appliance can receive audiovisual content information selected by the user and received from a content server.

19. The appliance of claim 14, wherein in response to receiving the one or more physiological data transmitted by the interactive audio-visual appliance during the second mode of operation, a second user of a second interactive audio-visual appliance can select to transmit audio-visual information to the interactive audio-visual appliance via the bi-directional transmission media.

20. A method for transmitting physiological content between remote locations, comprising:
collecting one or more physiological data;
providing the one or more physiological data to a first interactive audio-visual appliance at a first location during a remote communication mode of the first interactive audio-visual appliance;
transmitting the one or more physiological data from the first interactive audio-visual appliance to a second interactive audio-visual appliance at a second location during the remote communication mode of the first interactive audio-visual appliance via a bi-directional broadband transmission medium.

21. The method of claim 20, further comprising:
during a normal mode of operation of the first interactive audio-visual appliance, the first interactive audio-visual appliance receiving audiovisual content information selected by a user of the first interactive audio-visual appliance from a content server.

22. The method of claim 20, wherein in response to receiving the one or more physiological data transmitted by the first interactive audio-visual appliance during the second mode of operation, a second user of the second interactive audio-visual appliance transmitting audio-visual information to the first interactive audio-visual appliance via the bi-directional broadband transmission media.
